(19) United States
(12) Patent Application Publication
(10) Pub. No.: US 2020/0281054 A1
(43) Pub. Date: Sep. 3, 2020

(54) ELECTRODELESS DIMMING AND TONING FILL LAMP

(71) Applicant: Shenzhen Youbaise Technology Co., Ltd., SHENZHEN (CN)

(72) Inventor: DINGLAN LI, SHENZHEN (CN)

(21) Appl. No.: 16/289,734

(22) Filed: Mar. 1, 2019

(51) Int. Cl. H05B 33/08; H05B 37/02; H05B 41/39

(52) U.S. Cl. CPC H05B 33/0845; H05B 41/39; H05B 37/0272

(57) ABSTRACT

An electrodeless dimming and toning fill lamp includes a lamp body, a main board, a non-stroboscopic power source, and a holder. The holder includes a front shell, a back shell, and a support member. The non-stroboscopic power source and the main board are both received in the receiving cavity formed by the front shell and the back shell. The receiving cavity provides protect to the non-stroboscopic power source and the main board. The lamp body is fixedly connected to the holder, and the support member is capable of supporting the lamp body via the front shell. Other components, such as a dimming knob and a toning knob are arranged on the holder.

### TECHNICAL FIELD

The described embodiments relate to the field of illumination, and in particular to an electrodeless dimming and toning fill lamp.

### BACKGROUND

Fill lamp is one kind of lamps configured to provide illumination compensation for some devices or plants due to lack of illumination. An existing fill lamp generally includes a lamp body and a support member. For convenience of being used outdoor or in an environment without an external power source, the fill lamp includes a power source. However, the power source of the existing lamp body is disposed at an outer side of the fill lamp, and no special housing is provided to protect the power source. In this way, the fill lamp has a low safety. Besides, various components of the fill lamp have a lower integration, and the fill lamp has a poor appearance.

### SUMMARY

As to this, the present disclosure provides an electrodeless dimming and toning fill lamp, which comprises a special holder configured to protect the non-stroboscopic power source, such that the fill lamp has a high safety and a high integration of the components.

In one aspect, an electrodeless dimming and toning fill lamp is provided. The electrodeless dimming and toning fill lamp includes: a lamp body; a main board; a non-stroboscopic power source electrically connected to the lamp body via the main board; and a holder. The holder includes: a front shell fixedly connected to the lamp body; a back shell and a support member. The front shell and the back shell are connected to each other to form a receiving cavity having the function of receiving. The non-stroboscopic power source and the main board are both received in the receiving cavity. The support member is fixedly connected to the front shell, such that the support member is capable of supporting the lamp body via the front shell.

Further, the lamp body includes a rear cover made of aluminium alloy, a lampshade, a substrate, and a plurality of lamp beads; the lamp body is fixedly connected to the front shell of the holder via the rear cover; the rear cover is connected to the lampshade to form a housing; the substrate is fixed in the housing; the plurality of lamp beads are fixedly connected to the substrate and arranged along a circumference of the substrate.

Further, an inner sidewall of the lampshade defines a stripe-shaped groove configured to mix lights.

Further, the substrate is formed by four arc-shaped plates connected end to end.

Further, the rear cover defines a plurality of heat-dissipation holes.

Further, at least one connecting portion configured to be connected to an additional mechanism is further arranged on the front shell.

Further, the lampshade is in shape of an annulus, and the connecting portion is located corresponding to an annular position of the lampshade.

Further, the additional mechanism is located corresponding to the annular position of the lampshade when the additional mechanism is connected to connecting portion.

Further, the connecting portion comprises three dovetail grooves arranged side by side.

Further, one end of the support member is fixedly connected to the front shell, and the other end of the support member is screwed to an external bracket.

Further, the support member comprises a first support sub-member, a second support sub-member, and a rotating shaft; one end of the first support sub-member is fixedly connected to the front shell, and the other end of the first support sub-member is rotatably connected to the second support sub-member via the rotating shaft.

Further, a dimming knob and a toning knob are arranged on the front cover; the dimming knob and the toning knob are respectively and electrically connected to the main board.

Further, a switch is disposed on a sidewall of the front shell, and the switch is electrically connected to the main board.

Further, a power interface is arranged on the back shell, and the power interface is electrically connected to the non-stroboscopic power source.

Further, a USB interface is arranged on the front shell.

Further, the electrodeless dimming and toning fill lamp further includes a wireless signal transceiver and an intelligent dimmer, the wireless signal transceiver is configured to receive control information sent by an external terminal, and perform wireless dimming and toning of the lamp body via the intelligent dimmer.

In the electrodeless dimming and toning fill lamp disclosed in the present disclosure, compared with the related art, the non-stroboscopic power source and the main board are both received in the receiving cavity formed by the front shell and the back shell. The receiving cavity provides protect to the non-stroboscopic power source, thereby improving the safety of the fill lamp. Besides, other components, such as a dimming knob and a toning knob are arranged on the holder, such that the fill lamp has a high integration, and the fill lamp has a clean and beautiful appearance.

### BRIEF DESCRIPTION OF THE DRAWINGS

FIG. 1 is a schematic view showing an overall structure of an electrodeless dimming and toning fill lamp according to an embodiment of the present disclosure.

FIG. 2 is an exploded view of a holder of the electrodeless dimming and toning fill lamp according to an embodiment of the present disclosure.

FIG. 3 is an exploded view of a lamp body of the electrodeless dimming and toning fill lamp according to an embodiment of the present disclosure.

FIG. 4 is a cross-sectional view of a lampshade of the electrodeless dimming and toning fill lamp according to an embodiment of the present disclosure.

### LIST OF REFERENCE NUMBERS IN DRAWINGS

100 electrodeless dimming and toning fill lamp; 10 lamp body; 11 lampshade; 111 groove; 12 rear cover; 121 heat-dissipation hole; 13 substrate; 14 lamp bead; 20 holder; 21 front shell of the holder; 211 curved engaging slot; 212 connecting portion; 22 back shell of the holder; 23 support member; 231 first support sub-member; 232 second support sub-member; 233 rotating shaft; 234 clamping knob; 24 dimming knob; 25 toning knob; 26 switch; 30 main board; 40 non-stroboscopic power source.

### DETAILED DESCRIPTION

Technical solutions in embodiments of the present disclosure will be described clearly and completely with reference to accompanying drawings in the embodiments of the present disclosure. It should be noted that when a component is considered to be “connected” to another component, the component may be directly connected to another component, or it is also possible to provide an intervening component therebetween. All technical and scientific terms used herein have the same meaning as commonly understood by those skilled in the art, unless otherwise defined. It should also be noted that, unless explicitly stated and defined, otherwise, terms “installed”, “connected”, and “coupled” should be understood broadly. For example, it may be fixed connections, detachable connections, or integral connections; it may also be mechanical or electrical connections; it may also be inner communications of two elements, as can be understood by one skilled in the art depending on specific contexts. The terms used in the specification of the present disclosure are for the purpose of describing specific embodiments and are not intended to limit the present disclosure.

It should also be noted that, in the specification of the present disclosure, the terms “center”, “upper”, “lower”, “left”, “right”, “vertical”, “horizontal”, “inner”, “outer”, and the like, refer to the orientations and locational relations illustrated in the accompanying drawings. Thus, the directional terms used here are only for better and more clearly describing and understanding the present disclosure, and are not intended to indicate or imply that the devices or the elements are disposed to locate at the specific directions or are structured and performed in the specific directions, which could not to be understood as limiting the present disclosure. Moreover, terms “first”, “second”, “third”, and the like are used herein for purposes of description, and are not intended to indicate or imply relative importance or significance.

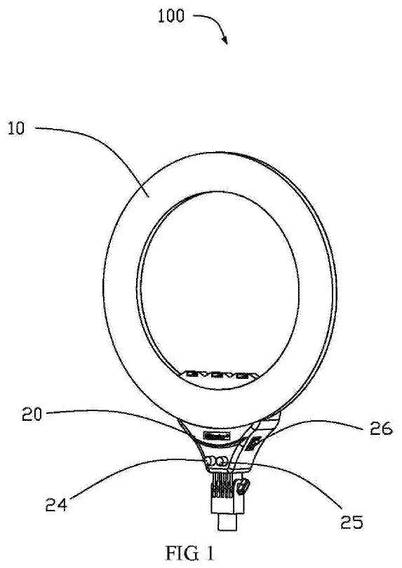

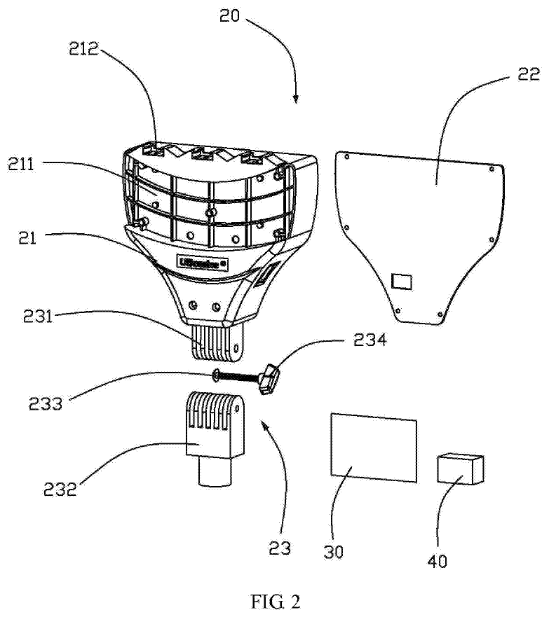

As shown in FIG. 1 and FIG. 2, the present disclosure discloses an electrodeless dimming and toning fill lamp 100, which has an improved safety. Besides, various components of the lamp body have a high integration, and the whole fill lamp has a clean and beautiful appearance. The electrodeless dimming and toning fill lamp 100 includes a lamp body 10, a holder 20, a main board 30, and a non-stroboscopic power source 40. The main board 30 and the non-stroboscopic power source 40 are disposed inside the holder 20, and the holder 20 provides a support to the lamp body 10.

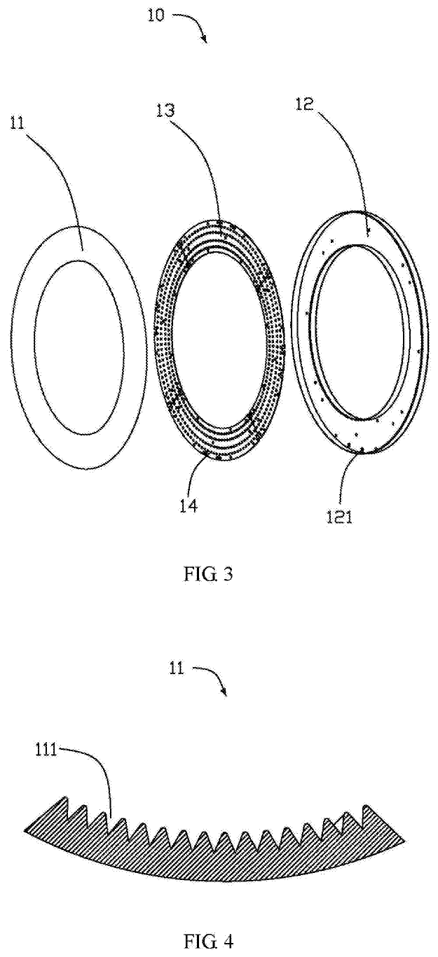

As shown in FIGS. 3 and 4, the lamp body 10 includes a lampshade 11, an rear cover 12, a substrate 13, and a plurality of lamp beads 14. The lampshade 11 and the rear cover 12 are each in shape of an annulus, and the lampshade 11 is connected to the rear cover 12, such that a housing having a receiving space is formed by the lampshade 11 and the rear cover 12, and the substrate 13 is fixedly received in the housing. The plurality of lamp beads 14 are fixedly connected to the substrate 13 and are arranged on the substrate 13 in an annulus, that is to say, the plurality of lamp beads 14 are arranged along a circumference of the substrate 13. In some embodiments, the substrate 13 is formed by four arc-shaped plates connected end to end, and the annular substrate 13 formed by the four arc-shaped plates has a shape matching with those of the rear cover 12 and the lampshade 11. The lampshade 11 is made of PC material and have a good light transmission effect. Moreover, in order to make lights emitted out of the lamp body 10 uniform, the lampshade 11 has a design of light mixing. More specifically, a plurality of stripe-shaped grooves 111 are evenly defined at an inner sidewall of the lampshade 11, in order to facilitate refraction of lights. In some embodiments, the groove 111 has a cross section in shape of a triangle. The rear cover 12 defines a plurality of heat-dissipation holes 121 configured to perform the heat dissipation of the lamp body 10. The rear cover 12 is made of aluminum metal, such as aluminum alloy, and has a good thermal conductivity. In this way, it is easy to conduct the heat generated by the plurality of lamp beads 14 to the outside, and further improve the heat dissipation effect.

As shown in FIG. 2 and FIG. 3, the holder 20 is disposed at a lower end on a back surface of the rear cover 12, and is fixedly connected to the lamp body 10 through the rear cover 12. The holder 20 includes a front shell 21, a back shell 22, and a support member 23. The front shell 21 defines a curved engaging slot 211, and the rear cover 12 is connected to the holder 20 via the curved engaging slot 211, such that the rear cover 12 is partially engaged in the engaging slot 211, and the lamp body 10 is fastened to the holder 20. That is to say, the rear cover 12 partially extends out of the engaging slot 211, and is further connected to the holder 20. In this embodiment, the front shell 21 and the back shell 22 are connected to each other to form a receiving cavity having the function of receiving. The non-stroboscopic power source 40 and the main board 30 are received in the receiving cavity. The non-stroboscopic power source 40 is electrically connected to the substrate 13 through the main board 30, and is further electrically connected to the plurality of lamp beads 14. The support member 23 is connected to an outer side of the front shell 21, and provides a support to the lamp body 10 via the front shell 21.

In one embodiment, one end of the support member is fixedly connected to the front shell 21 of the holder, and the other end of the support member is screwed to an external bracket. In this way, the lamp body 10 is firmly connected; however, the angle of the lamp body 10 cannot be adjusted.

In another embodiment, the support member 23 includes a first support sub-member 231, a second support sub-member 232, and a rotating shaft 233. One end of the first supporting member 231 is fixedly connected to the front shell 21, and the other end of the first supporting member 231 is rotatably connected to the second support sub-member 232 via the rotating shaft 233, such that the angle of the lamp body 10 can be adjusted, and it is possible to manually perform the dimming and toning. In this embodiment, the rotating shaft 233 passes through end portions respectively of the first support sub-member 231 and the second support sub-member 232. Besides, the end portion of the first support sub-member 231 is clamped with that of the second support sub-member 232. One end of the rotating shaft 233 is provided with a clamping knob 234. The clamping knob 234 is rotatable to adjust the clamping degree between the first supporting member 231 and the second supporting member 232.

At least one connecting portion 212 is arranged on the front shell 21. The lampshade 11 includes an inner ring and an outer ring. The connecting portion 212 is located corresponding to an annular position of the lampshade 11, that is, located corresponding to the inner ring of the lampshade 11. The connecting portion 212 is configured to be connected to an additional mechanism or product. For example, the connection portion 212 is connected to a mobile phone, a microphone, a sound card, a mirror, and the like. When the additional mechanism or product is attached to the connecting portion 212, the additional mechanism or product is located at the annular position of the lampshade 11, that is, located corresponding to the inner ring of the lampshade 11. In the present embodiment, the connecting portion 212 defines three dovetail grooves arranged side by side.

In this embodiment, a dimming knob 24 and a toning knob 25 is arranged on the front cover 21, and the dimming knob 24 and the toning knob 25 are respectively and electrically connected to the main board 30. The dimming knob 24 is configured to adjust the brightness of the lamp body 10, and the toning knob 25 is configured to adjust the color temperature of the lamp body 10. The dimming knob 24 and the toning knob 25 are both disposed at one side of the front shell 21 corresponding to the lampshade 11, that is to say, the side close to the lampshade 11, in order to facilitate the brightness and color adjustment of the lamp body 10 during the usage of the lamp body 10.

A switch 26 is disposed on a sidewall of the front shell 21. The switch 26 is electrically connected to the main board 30, and configured to turn on and off the lamp body 10.

A power interface is arranged on the back shell 22. The power interface is electrically connected to the non-stroboscopic power source 40, and configured to be connected to an external power source.

In some embodiments, a USB interface is arranged on the front shell.

In this embodiment, a wireless signal transceiver and an intelligent dimmer is further disposed in the receiving cavity. The wireless signal transceiver is electrically connected to the intelligent dimmer, and the intelligent dimmer is electrically connected to the main board 30. The wireless signal transceiver is configured to receive control information sent by an external terminal, and wirelessly transmit the control information to the intelligent dimmer. The intelligent dimmer further performs the dimming and toning of the lamp body 10.

The present disclosure has various embodiments and modifications without departing from the spirit and scope of the present disclosure. The above embodiments are only used to describe the present disclosure, and are not intended to limit the present disclosure.

1. An electrodeless dimming and toning fill lamp, comprising:
a lamp body, wherein the lamp body includes a rear cover, a lampshade, a substrate, and a plurality of lamp beads: the lamp body is fixedly connected to the front shell of the holder via the rear cover; the rear cover is connected to the lampshade to form a housing; the substrate is fixed in the housing and is formed by four arc-shaped plates connected end to end; the plurality of lamp beads are fixedly connected to the substrate and arranged along a circumference of the substrate;
a main board;
a non-stroboscopic power source, electrically connected to the lamp body via the main board; and
a holder, comprising:
a front shell, fixedly connected to the lamp body;
a back shell, wherein the front shell and the back shell are connected to each other to form a receiving cavity; the non-stroboscopic power source and the main board are both received in the receiving cavity; and
a support member, fixedly connected to the front shell, such that the support member is capable of supporting the lamp body via the front shell.

2. (canceled)

3. The electrodeless dimming and toning fill lamp according to claim 2, wherein an inner sidewall of the lampshade defines a stripe-shaped groove configured to mix lights.

4. The electrodeless dimming and toning fill lamp according to claim 3, wherein the groove has a cross section in shape of a triangle.

5. The electrodeless dimming and toning fill lamp according to claim 2, wherein the front shell defines a curved engaging slot; the rear cover partially extends out of the engaging slot, and is further connected to the holder.

6. (canceled)

7. The electrodeless dimming and toning fill lamp according to claim 2, wherein the rear cover defines a plurality of heat-dissipation holes.

8. The electrodeless dimming and toning fill lamp according to claim 2, wherein at least one connecting portion configured to be connected to an additional mechanism is further arranged on the front shell.

9. The electrodeless dimming and toning fill lamp according to claim 8, wherein the lampshade is in shape of an annulus, and comprises an inner ring and an outer ring; the connecting portion is located corresponding to the inner ring of the lampshade.

10. The electrodeless dimming and toning fill lamp according to claim 9, wherein the additional mechanism is located corresponding to the inner ring of the lampshade when the additional mechanism is connected to connecting portion.

11. The electrodeless dimming and toning fill lamp according to claim 10, wherein the connecting portion comprises three dovetail grooves arranged side by side.

12. The electrodeless dimming and toning fill lamp according to claim 1, wherein one end of the support member is fixedly connected to the front shell, and the other end of the support member is screwed to an external bracket.

13. The electrodeless dimming and toning fill lamp according to claim 1, wherein the support member comprises a first support sub-member, a second support sub-member, and a rotating shaft; one end of the first support sub-member is fixedly connected to the front shell, and the other end of the first support sub-member is rotatably connected to the second support sub-member via the rotating shaft.

14. The electrodeless dimming and toning fill lamp according to claim 13, wherein the rotating shaft passes through end portions respectively of the first support sub-member and the second support sub-member; the end portion of the first support sub-member is clamped with that of the second support sub-member.

15. The electrodeless dimming and toning fill lamp according to claim 14, wherein a rotatable clamping knob configured to adjust the clamping degree between the first supporting member and the second supporting member is arranged at one end of the rotating shaft.

16. The electrodeless dimming and toning fill lamp according to claim 1, wherein a dimming knob and a toning knob are arranged on the front cover; the dimming knob and the toning knob are respectively and electrically connected to the main board.

17. The electrodeless dimming and toning fill lamp according to claim 16, wherein a switch is disposed on a sidewall of the front shell, and the switch is electrically connected to the main board.

18. The electrodeless dimming and toning fill lamp according to claim 17, wherein a power interface is arranged on the back shell, and the power interface is electrically connected to the non-stroboscopic power source.

19. The electrodeless dimming and toning fill lamp according to claim 18, wherein a USB interface is arranged on the front shell.

20. (canceled)
